(19) United States
(12) Patent Application Publication
(10) Pub. No.: US 2017/0158160 A1
(43) Pub. Date: Jun. 8, 2017

(54) AIRBAG AND AIRBAG APPARATUS

(71) Applicants: Sakae SUGIMORI, Tokyo (JP); Kazuhiro HARAZUKA, Tokyo (JP); Takuya KUSUMURA, Tokyo (JP)

(72) Inventors: Sakae SUGIMORI, Tokyo (JP); Kazuhiro HARAZUKA, Tokyo (JP); Takuya KUSUMURA, Tokyo (JP)

(73) Assignee: Takata Corporation, Tokyo (JP)

(21) Appl. No.: 15/361,676

(22) Filed: Nov. 28, 2016

(30) Foreign Application Priority Data
Dec. 3, 2015 (JP) 2015-236998

(51) Int. Cl. B60R 21/237; B60R 21/264; B60R 21/207

(52) U.S. Cl. CPC B60R 21/237; B60R 21/207; B60R 21/264; B60R 2021/0006

(57) ABSTRACT

An airbag for storage at an inner side of the backrest in a vehicle width direction includes a lower folded portion made by folding a lower area of the airbag that is to be situated at a lower side of vehicle upon inflation and deployment, an upper folded portion made by folding an upper area of the airbag that is to be situated at an upper side of vehicle upon the inflation and deployment, and a middle folded portion made by folding a middle area of the airbag that is to be situated between the lower area and the upper area upon the inflation and deployment, wherein the middle folded portion is a roll-folded portion such that a face of the airbag facing away from the inner side upon the inflation and deployment faces inward in the roll-folded portion, the roll-folded portion having the upper folded portion wrapped therein.

### BACKGROUND OF THE INVENTION

1. Field of the Invention

The disclosures herein relate to an airbag and an airbag apparatus.

2. Description of the Related Art

Airbags known in the art that are stored at a side of the backrest of a seat include an airbag stored at an outer side of the backrest in the vehicle width direction and an airbag stored at an inner side of the backrest in the vehicle width direction. In response to an impact applied in the vehicle width direction at the side of the vehicle body, the former airbag inflates and deploys toward a space between the impacted side of the vehicle body and an occupant sitting in the seat situated nearer to the impacted side. On the other hand, in response to an impact applied in the vehicle width direction at the side of the vehicle body, the latter airbag inflates and deploys toward a space between the seat situated nearer to the impacted side and an occupant sitting in the seat situated farther away from the impacted side.

An airbag stored at a side of the backrest of a seat may hit an arm of the occupant upon inflation and deployment. In the case of an airbag stored at an outer side of the backrest in the vehicle width direction, the deployment path of the airbag is guided by the impacted side of the vehicle body even if the airbag upon inflation and deployment hits the arm of the occupant. The airbag is thus unlikely to deflect away from the occupant.

In the case of an airbag stored at an inner side of the backrest in the vehicle width direction, no guide such as the side of the vehicle body exists between the occupant sitting in the seat farther away from the impacted side and the seat situated nearer to the impacted side. Because of this, the airbag upon hitting an arm of the occupant during inflation and deployment is likely to have a deployment path deflecting away from the occupant.

Accordingly, it is an object of at least one embodiment of the present invention to cause the deployment path of an airbag to be unlikely to deflect away from an occupant upon the inflation and deployment of the airbag stored at an inner side of a backrest in the vehicle width direction.

### [Patent Document 1] Japanese Patent Application Publication No. 2012-81958

### SUMMARY OF THE INVENTION

It is a general object of the present invention to provide an airbag that substantially obviates one or more problems caused by the limitations and disadvantages of the related art.

According to an embodiment, an airbag for installation in a backrest of a seat disposed in a vehicle and for storage in a folded state at an inner side of the backrest in a vehicle width direction includes a lower folded portion made by folding a lower area of the airbag that is to be situated at a lower side of vehicle upon inflation and deployment of the airbag, an upper folded portion made by folding an upper area of the airbag that is to be situated at an upper side of vehicle upon the inflation and deployment of the airbag, and a middle folded portion made by folding a middle area of the airbag that is to be situated between the lower area and the upper area upon the inflation and deployment of the airbag, wherein the middle folded portion is a roll-folded portion such that a face of the airbag facing away from the inner side upon the inflation and deployment of the airbag faces inward in the roll-folded portion, the roll-folded portion having the upper folded portion wrapped therein.

According to at least one embodiment, the deployment path of an airbag is unlikely to deflect away from an occupant upon the inflation and deployment of the airbag stored at an inner side of a backrest in the vehicle width direction.

### BRIEF DESCRIPTION OF THE DRAWINGS

Other objects and further features of the present invention will be apparent from the following detailed description when read in conjunction with the accompanying drawings, in which:

FIG. 1 is a schematic front view illustrating an example of an inflated and deployed airbag that is stored at an inner side of a backrest in a vehicle width direction;

FIG. 2 is a schematic side elevation view illustrating an example of the inflated and deployed airbag that is stored at the inner side of the backrest in the vehicle width direction;

FIG. 3 is a schematic view illustrating an example of the configuration of the airbag apparatus with the airbag being in an uninflated state;

FIG. 4 is a schematic cross-sectional view taken along the line B-B illustrated in FIG. 3;

FIG. 5 is a schematic side elevation view illustrating an example of the airbag apparatus in an unfolded state prior to the folding of the airbag;

FIG. 6 is a schematic cross-sectional view taken along the line D1-D1 in FIG. 5;

FIG. 7 is a schematic side elevation view illustrating an example of the airbag apparatus with the upper area of the airbag being folded;

FIG. 8 is a schematic cross-sectional view taken along the line E1-E1 in FIG. 7;

FIG. 9 is a schematic side elevation view illustrating an example of the airbag apparatus with the middle area of the airbag being folded;

FIG. 10 is a schematic cross-sectional view taken along the line G1-G1 in FIG. 9;

FIG. 11 is a schematic side elevation view illustrating an example of the airbag apparatus with the lower area of the airbag being folded;

FIG. 12 is a schematic side elevation view illustrating an example of the airbag apparatus with the upper area of the airbag being folded;

FIG. 13 is a schematic cross-sectional view taken along the line E2-E2 in FIG. 12;

FIG. 14 is a schematic side elevation view illustrating an example of the airbag apparatus with the middle area of the airbag being folded;

FIG. 15 is a schematic cross-sectional view taken along the line G2-G2 in FIG. 14;

FIG. 16 is a schematic side elevation view illustrating an example of the airbag apparatus with the upper area of the airbag being folded;

FIG. 17 is a schematic cross-sectional view taken along the line E3-E3 in FIG. 16;

FIG. 18 is a schematic side elevation view illustrating an example of the airbag apparatus with the middle area of the airbag being folded;

FIG. 19 is a schematic cross-sectional view taken along the line G3-G3 in FIG. 18;

FIG. 20 is a schematic side elevation view illustrating an example of the airbag apparatus with the upper area of the airbag being folded;

FIG. 21 is a schematic cross-sectional view taken along the line E4-E4 in FIG. 20;

FIG. 22 is a schematic side elevation view illustrating an example of the airbag apparatus with the middle area of the airbag being folded;

FIG. 23 is a schematic cross-sectional view taken along the line G4-G4 in FIG. 22;

FIG. 24 is a schematic side elevation view illustrating an example of the airbag apparatus with the upper area of the airbag being folded;

FIG. 25 is a schematic cross-sectional view taken along the line E5-E5 in FIG. 24;

FIG. 26 is a schematic side elevation view illustrating an example of the airbag apparatus with the middle area of the airbag being folded; and

FIG. 27 is a schematic cross-sectional view taken along the line G5-G5 in FIG. 26.

### DESCRIPTION OF THE PREFERRED EMBODIMENTS

In the following, embodiments of the present invention will be described with reference to the accompanying drawings.

### <Example of Configuration of Airbag Apparatus>

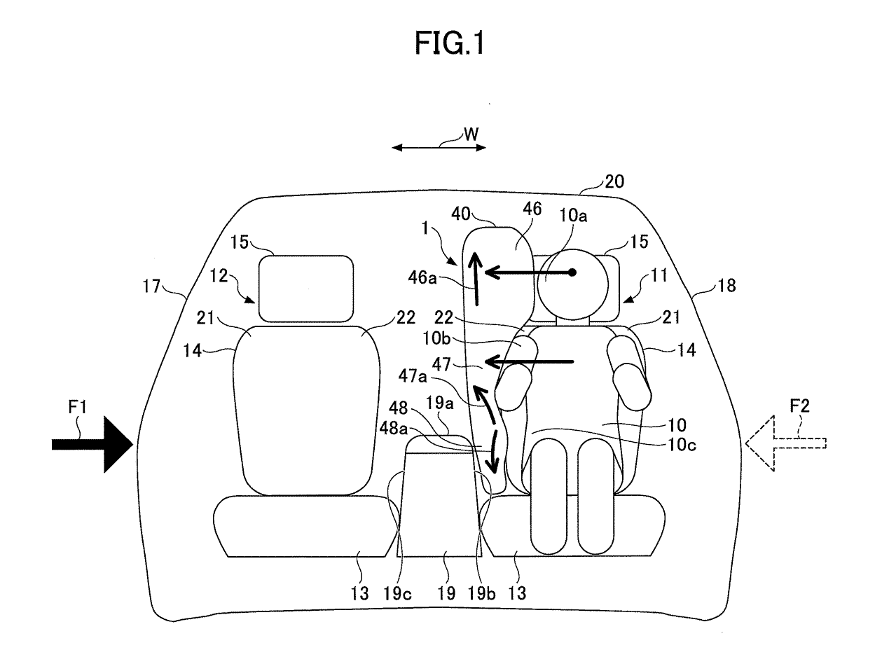

FIG. 1 is a schematic front view illustrating an example of an airbag 40 that is inflated and deployed. This transparent view of a vehicle 20 is taken from the front side of the vehicle 20. The vehicle 20 includes a plurality of seats arranged side by side in the width direction of the vehicle 20 (i.e., in the vehicle width direction W). One of the seats 11 and 12 adjacent to each other is a driver's seat, and the other is a passenger seat, for example. FIG. 1 illustrates an occupant 10 sitting in the seat 11.

A center console 19 is situated between the seat 11 and the seat 12. The center console 19 has an operation unit such as operation switches and a storage unit such as a cup holder, for example. The center console 19 has an upper face 19a, a side face 19b situated toward the seat 11, and a side face 19c situated toward the seat 12.

Each of the seats 11 and 12 includes a seat bottom 13 on which the buttocks of the occupant are placed, a backrest 14 projecting upward from the rear side of the seat bottom 13, and a headrest 15 disposed on the top of the backrest 14. The backrest 14 receives the back of the occupant.

The backrest 14 includes a side 21 situated on the outer side in the vehicle width direction W and a side 22 situated on the inner side in the vehicle width direction W. An airbag apparatus 1 of the present embodiment is an occupant restraining apparatus that is stored at the inner side 22 of the backrest 14 in the vehicle width direction when an airbag 40 is in an uninflated state prior to inflation and deployment.

In the case of detecting an impact F1 applied to a body side 17 of the vehicle 20 from one side in the vehicle width direction W, for example, the airbag apparatus 1 inflates and deploys the airbag 40 situated at the side 22 of the seat 11 on the far side from the body side 17. With this arrangement, the airbag 40, which is inflated and deployed toward the side face 19b of the center console 19 and toward an upper space over the upper face 19a of the center console 19, receives the upper body of the occupant 10 sitting in the seat 11 when the upper body of the occupant 10 moves toward the body side 17 due to the inertia.

FIG. 1 illustrates the case in which the airbag apparatus 1 is stored at the side 22 of the backrest 14 of the seat 11. Alternatively, the airbag apparatus 1 may be stored at the side 22 of the backrest 14 of the seat 12. In the case of detecting an impact F2 applied to another body side of the vehicle 20 from another side in the vehicle width direction W, for example, the airbag apparatus 1 disposed on the seat 12 inflates and deploys the airbag 40 situated at the side 22 of the seat 12 on the far side from the body side 18. With this arrangement, the airbag 12, which is inflated and deployed toward the side face 19c of the center console 19 and toward an upper space over the upper face 19a of the center console 19, receives the upper body of the occupant sitting in the seat 12 when the upper body of the occupant moves toward the body side 18 due to the inertia.

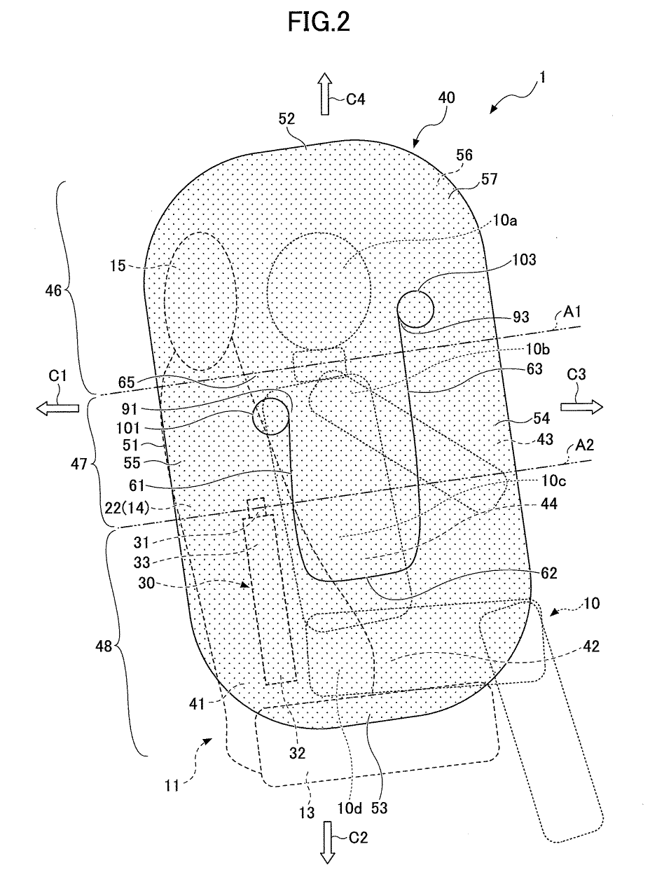

FIG. 2 is a schematic side elevation view illustrating the inflated and deployed airbag 40 as viewed from one side in the vehicle width direction. The illustrated airbag apparatus 1 is installed in the backrest 14 of the seat 11 disposed in the vehicle, and is an airbag module stored at the inner side 22 of the backrest 14 in the vehicle width direction.

The airbag apparatus 1 includes the airbag and an inflator 30. FIG. 2 illustrates the inflated and deployed airbag 40 installed in the vehicle in a side view taken in the vehicle width direction. Arrows C1, C2, C3, and C4, which represent directions in which the airbag 40 stored in the backrest 14 inflates and deploys, point to the rear side of the vehicle, the bottom side of the vehicle, the front side of the vehicle, and the top side of the vehicle, respectively.

The airbag 40 is an occupant restraining member configured to inflate and deploy toward an upper space over the upper face 19a of the center console 19 and toward the side face 19c of the center console 19 in response to gas supplied from an upper end 31 of the inflator 30.

The airbag 40, which is installed in the backrest 14 of the seat 11 disposed in the vehicle, is an example of an airbag stored in a folded state at the inner side 22 of the backrest 14 in the vehicle width direction. The airbag 40 is configured to inflate into a substantially rectangular shape standing substantially upright. The airbag 40 in the inflated and deployed state includes an upper area for receiving a head 10a of the occupant 10, a middle area 47 for receiving an arm 10b (shoulder in particular) of the occupant, and a lower area 48 for receiving an abdominal area 10c and lumbar area 10d of the occupant. The upper area 46 and the middle area 47, for example, inflate and deploy toward an upper space over the center console 19. The lower area 48 inflates and deploys toward a space between the side face of the center console 19 and both the abdominal area 10c and the lumbar area 10d.

The upper area 46 is situated on an upper side in the vehicle when the airbag 40 is inflated and deployed. The lower area 48 is situated on a lower side in the vehicle when the airbag 40 is inflated and deployed. The middle area 47 is situated between the lower area 48 and the upper area 46 when the airbag 40 is inflated and deployed. A dotted and dashed line A1 indicates the boundary between the upper area 46 and the middle area 47 in a side view taken in the vehicle width direction. A dotted and dashed line A2 indicates the boundary between the lower area 48 and the middle area 47 in a side view taken in the vehicle width direction.

When the airbag 40 installed in the vehicle is viewed in the vehicle width direction upon inflation and deployment, the airbag 40 has a substantially rectangular shape having an upper periphery 52, a lower periphery 53, a rear periphery 55, and a front periphery 54. The longitudinal direction of the airbag 40 corresponds to a straight line passing through the upper periphery 52 and the lower periphery 53. When the airbag 40 installed in the vehicle is inflated and deployed, the rear periphery 55 is a rear edge situated toward the rear of the vehicle, and the front periphery 54 is a front edge situated toward the front of the vehicle.

The airbag 40 includes a first panel 56 and a second panel 57 that have substantially the same size. The airbag 40 is an example of an airbag made by bonding the perimeter of the first panel 56 and the perimeter of the second panel 57 to each other while the first panel 56 and the second panel 57 are placed one over another. The perimeter of the first panel 56 and the perimeter of the second panel are bonded by stitching or the like. Upon the inflation and deployment of the airbag 40, the first panel 56 is a surface panel facing toward the backrest 14 (i.e., toward the occupant 10), and the second panel 57 is a surface panel situated facing away from the backrest 14 (i.e., away from the occupant 10).

The airbag 40 has a line-shaped bonding portion for bonding the first panel 56 and the second panel 57 placed one over another along the upper periphery 52, the lower periphery 53, the rear periphery 55, and the front periphery 54 by stitching or the like. Part of the perimeter of the overlapped panels has a non-bonded portion at which bonding is not performed. The non-bonded portion allows the inflator 30 to be inserted into the airbag 40. The non-bonded portion is situated at the lower rear periphery between the rear periphery 55 and the lower periphery 53, for example.

Alternatively, the airbag 40 may be a bag-shaped member made by folding a single substantially symmetrical panel along a fold line 51 (i.e., line of symmetry). The single substantially symmetrical panel, before being folded along the fold line 51, has a right panel face on the right of the fold line and a left panel face on the left of the fold line 51. In this case, the right panel face corresponds to the first panel 56, and the left panel face corresponds to the second panel 57. The rear periphery 55 positioned along the fold line 51 is not bonded along any bonding portion.

The airbag 40 includes a rear bonding portion 61, a lower bonding portion 62, and a front bonding portion 63. The rear bonding portion 61 is an example of a line-shaped bonding portion for bonding the first panel 56 and the second panel 57 to each other by stitching or the like along the rear periphery 55 of the airbag 40. The lower bonding portion 62 is an example of a line-shaped bonding portion for bonding the first panel 56 and the second panel 57 to each other by stitching or the like along the lower periphery 53 of the airbag 40. The front bonding portion 63 is an example of a line-shaped bonding portion for bonding the first panel 56 and the second panel 57 to each other by stitching or the like along the front periphery 54 of the airbag 40.

The airbag 40 includes a first chamber 41, a second chamber 42, a third chamber 43, and a fourth chamber 44. The first chamber 41 is a first inflating portion that inflates between the rear periphery 55 and the rear bonding portion 61. The second chamber 42 is a second inflating portion that inflates between the lower periphery 53 and the lower bonding portion 62. The third chamber 43 is a third inflating portion that inflates between the front periphery 54 and the front bonding portion 63. The fourth chamber 44 is a fourth inflating portion that inflates between the rear bonding portion 61 and the front bonding portion 63 as well as between the lower bonding portion 62 and the upper periphery of the airbag 40. The rear bonding portion 61, the lower bonding portion 62, and the front bonding portion 63 are continuously connected in a line without having any non-bonded portion.

The boundary between the first chamber 41 and the second chamber 42 is situated on an imaginary extension line of the rear bonding portion when the airbag 40 is in an unfolded but uninflated state, with the first chamber 41 and the second chamber 42 being in communication with each other at the boundary. The boundary between the third chamber 43 and the second chamber 42 is situated on an imaginary extension line of the front bonding portion 63 when the airbag 40 is in an unfolded but uninflated state, with the third chamber 43 and the second chamber 42 being in communication with each other at the boundary.

The first chamber 41 is in communication with the fourth chamber 44 at a non-bonded portion 65 situated between the rear bonding portion 61 and the upper periphery 52. Communication between the first chamber 41 and the fourth chamber 44 through the non-bonded portion 65 allows gas inside the first chamber 41 to be smoothly supplied to the fourth chamber 44, thereby enabling the smooth inflation and deployment of the fourth chamber 44.

The first chamber 41 has the inflator 30 accommodated therein such that the longitudinal direction of the inflator 30 is aligned with the vertical direction of the airbag 40. The first chamber 41 serves as an inflation chamber that inflates at the bottom side of the airbag 40 toward the rear of the vehicle when the airbag 40 inflates and deploys upon being ejected from the backrest 14.

The airbag 40 includes a first bonding end 101 and a second bonding end 103. The first bonding end 101, which is connected to an end 91 of the rear bonding portion 61, is an example of an annular connecting portion at which the first panel 56 and the second panel 57 are bonded to each other by stitching or the like. The second bonding end 103, which is connected to an end 93 of the front bonding portion 63, is an example of an annular connecting portion at which the first panel 56 and the second panel 57 are bonded to each other by stitching or the like.

The provision of an annular bonding portion at the end of a line-shaped bonding portion serves to suppress the concentration of stress at such an end.

The inflator 30, which is an gas generator (i.e., gas supply unit) for generating gas for inflating and deploying the airbag 40, supplies gas to the airbag 40 to inflate and deploy the airbag 40. The backrest 14 has the substantially cylindrically-shaped inflator 30 stored at the side 22 such that the longitudinal direction of the inflator 30 is aligned with the longitudinal direction of the backrest 14.

The inflator 30 includes a cylindrical body 33, an upper end 31 situated toward the upper side of the backrest 14, and a lower end 32 situated toward the lower side of the backrest 14. The inflator 30 emits gas for inflating and deploying the airbag 40 from the discharge aperture formed at the protruding upper end 31. With this arrangement, the inflating airbag 40 is ejected from the side 22 to deploy between the abdominal area of the occupant and the side face of the center console 19 as well as toward an upper space over the center console 19.

In an uninflated state prior to the inflation and deployment of the airbag 40, the airbag apparatus 1 is stored at the side 22 with the airbag 40 being in a folded state.

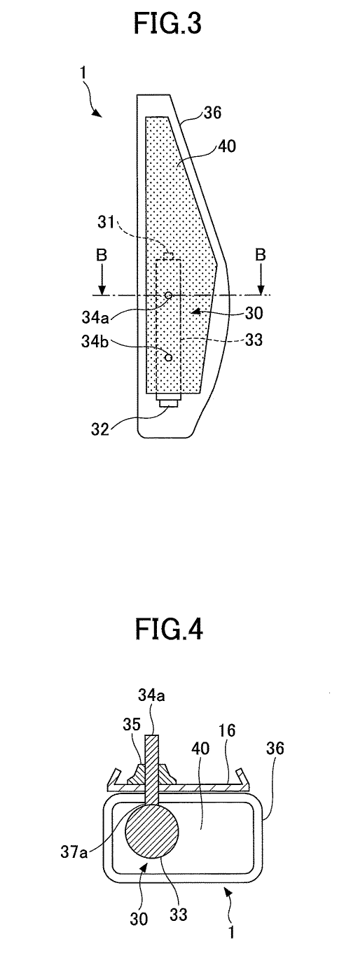

FIG. 3 is a schematic view illustrating an example of the configuration of the airbag apparatus 1 with the airbag 40 being in an uninflated state. FIG. 4 is a schematic cross-sectional view illustrating an example of the airbag apparatus 1 taken along the line B-B in FIG. 3. As illustrated in FIGS. 3 and 4, the inflator 30 has the cylindrical body 33 and two mounting legs 34a and 34b projecting from the lateral surface of the cylindrical body 33. The mounting legs 34 (34a and 34b) are threaded bolts. In order to prevent the folded airbag 40 from unfolding or being cut, the airbag apparatus 1 may be enclosed in a cover 36 or bound with a band. The cover 36 may be an unwoven cloth or resin case that is able to tear upon the inflation of the airbag 40, for example. The band may be a string-shaped member that is able to tear upon the inflation of the airbag 40. The shape of the folded airbag 40 is simplified in illustration.

The mounting legs 34 (34a and 34b) of the inflator 30 are inserted into the frame holes formed in a seat frame 16 inside the backrest 14 while the mounting legs 34 are placed in mounting holes 37 (37a and 37b) formed in the surface of the airbag 40. The mounting holes 37a and 37b are formed in the first panel 56 that faces toward the backrest 14 (i.e., toward the occupant 10) when the airbag 40 is inflated and deployed. The mounting leg 34a is inserted into the mounting hole 37a, and the other mounting leg 34b is inserted into the other mounting hole 37b. Nuts 35 are fastened to the mounting legs to secure the airbag apparatus 1 to the seat frame 16.

In the following, a description will be given of different examples of a method of folding the airbag 40 prior to the installation of the airbag apparatus 1 in the backrest 14.

### <First Method of Folding>

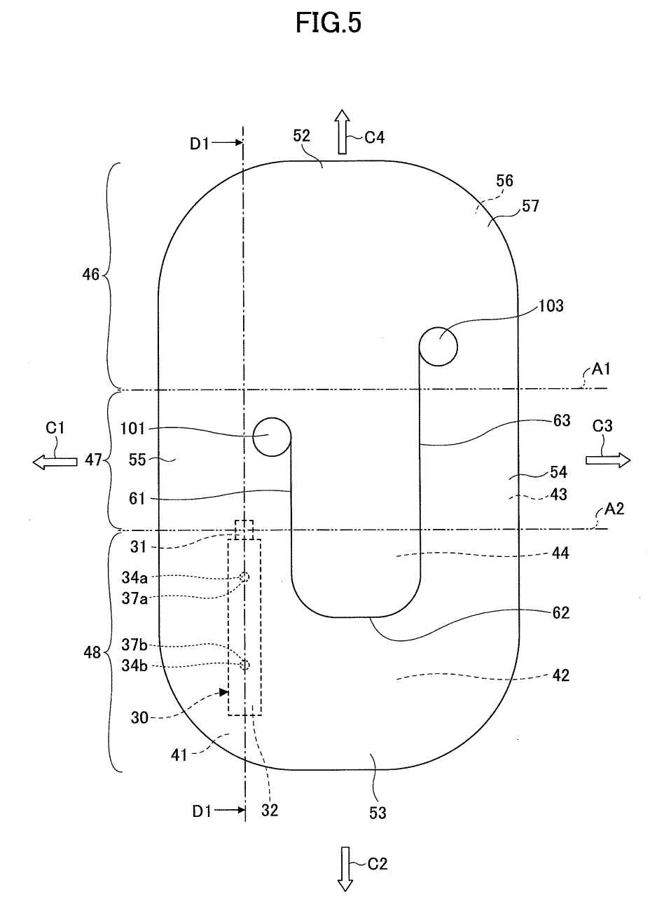

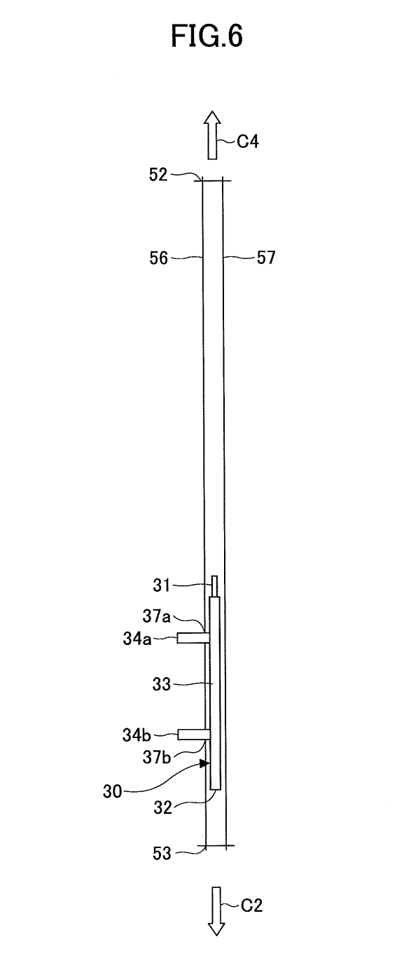

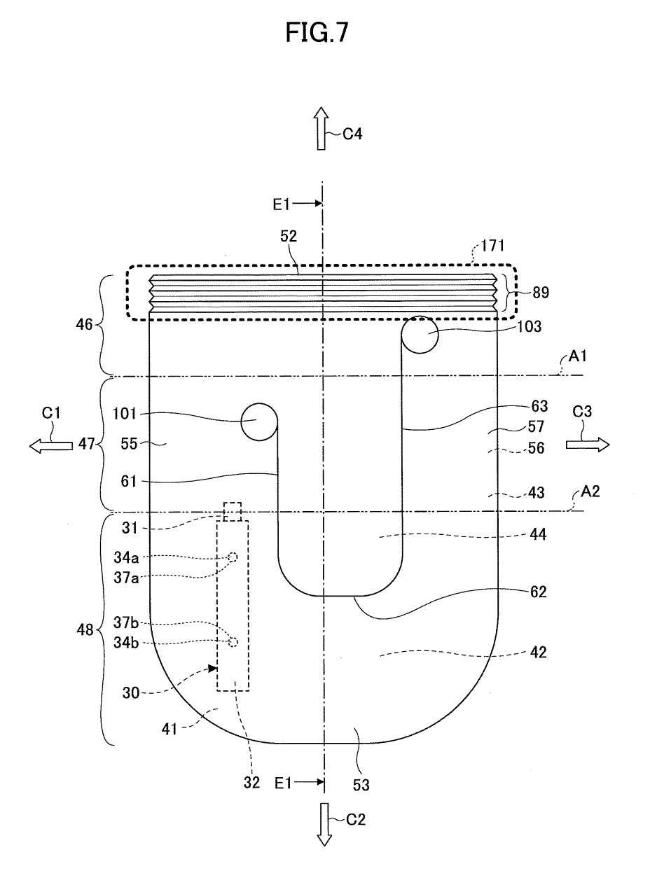

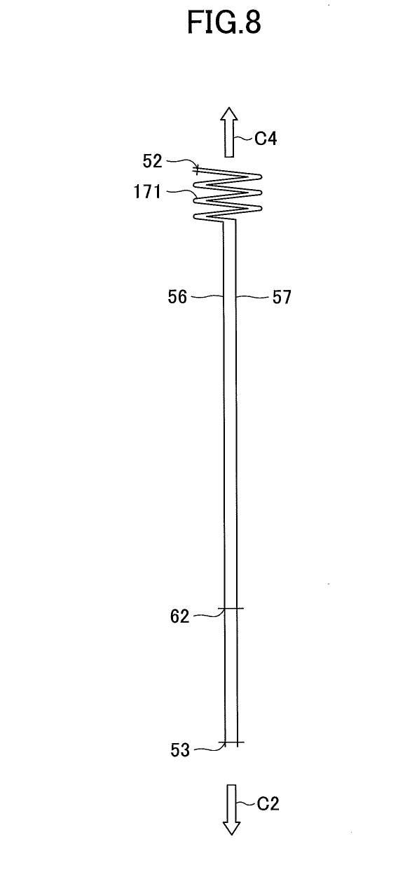

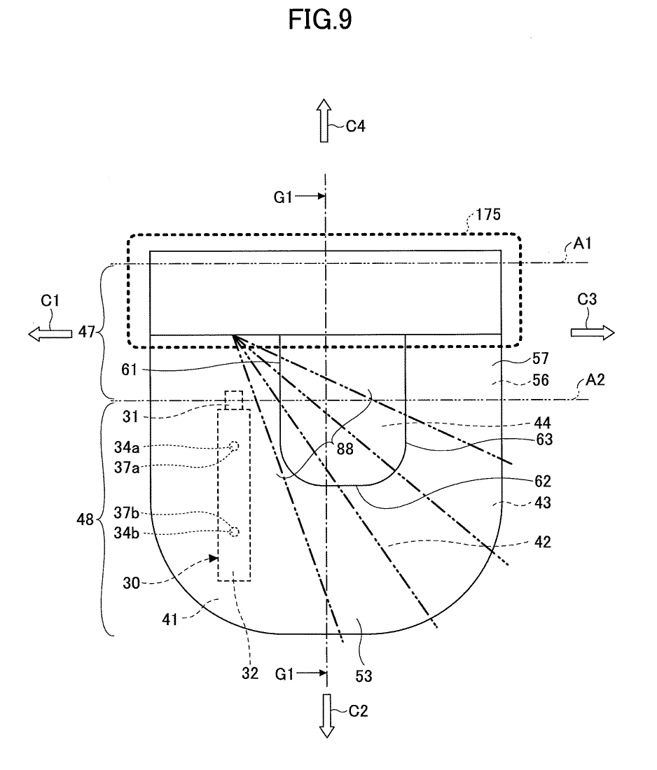

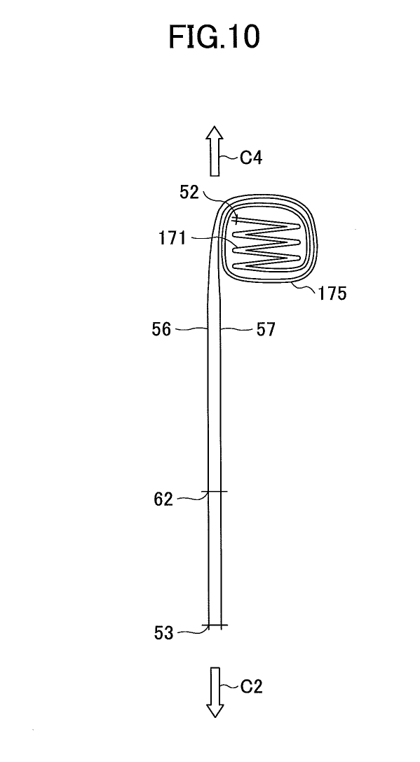

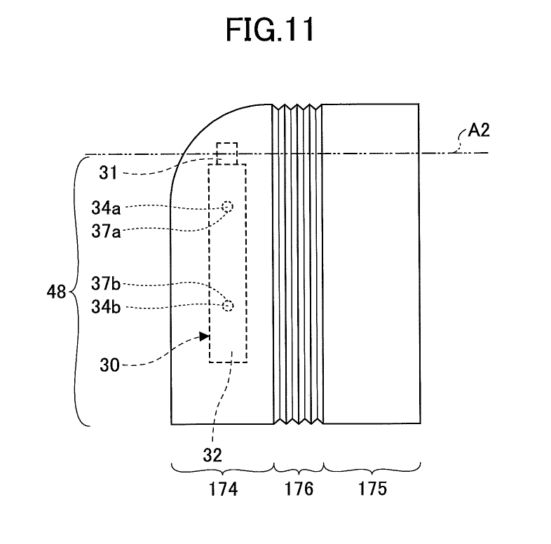

In the first method of folding, the steps of folding the airbag 40 are performed as illustrated in FIG. 5 (FIG. 6), FIG. 7 (FIG. 8), FIG. 9 (FIG. 10), and FIG. 11 in this order.

FIG. 5 is a schematic side elevation view illustrating an example of the airbag apparatus 1 in an unfolded state prior to the folding of the airbag 40. FIG. 6 is a schematic cross-sectional view taken along the line D1-D1 in FIG. 5. The mounting holes 37a and 37b are formed in the first panel 56. The mounting leg 34a is inserted into the mounting hole 37a situated toward the upper periphery 52, and the other mounting leg 34b is inserted into the mounting hole 37b situated toward the lower periphery 53.

FIG. 7 is a schematic side elevation view illustrating an example of the airbag apparatus 1 with the upper area 46 of the airbag 40 being folded. FIG. 7 illustrates an example of a plurality of fold lines 89. FIG. 8 is a schematic cross-sectional view taken along the line E1-E1 in FIG. 7. In FIGS. 7 and 8, the airbag 40 is folded in the longitudinal direction of the airbag 40 from the upper periphery 52 toward the lower periphery 53 such that the fold lines 89 are perpendicular to the longitudinal direction of the airbag 40. The way of folding along the fold lines 89 is the accordion fold that creates pleats resembling the bellows of an accordion.

At least part of the upper area 46 of the airbag 40 is folded multiple times along the fold lines 89 to create an upper folded portion 171. The upper folded portion 171 is a portion made by accordion-folding at least part of the upper area 46, which is to be situated at the upper side of the airbag 40 upon inflation and deployment.

FIG. 9 is a schematic side elevation view illustrating an example of the airbag apparatus 1 with the middle area 47 of the airbag 40 being folded. FIG. 10 is a schematic cross-sectional view taken along the line G1-G1 in FIG. 8. In FIGS. 9 and 10, at least part of the middle area 47 of the airbag 40 is roll-folded with the second panel 57 facing inward (which may referred to as “outward roll fold”) such that the upper case part 171 is wrapped in the roll, thereby creating a middle folded portion 175. The middle folded portion 175 is an outward-roll-folded portion made of at least part of the middle area 47 situated between the upper area 46 and the lower area 48 upon the inflation and deployment of the airbag 40. The middle area 47 is outward-roll-folded up to slightly above the mounting hole 37a.

The middle folded portion 175 is an outward-roll-folded portion of the middle area 47 in which the upper folded portion 171 is wrapped. The outward-roll-fold in this context means that the roll is created such that the face (outside face) of the airbag 40 opposite the face (inside face) facing toward the side 22 upon inflation and deployment faces inward in the roll.

FIG. 9 illustrates an example of a plurality of fold lines 88. With the form of the middle folded portion 175 wrapped around the upper folded portion 171 being intact, part of the lower area 48 of the airbag 40 is folded multiple times toward the inflator 30, thereby creating a lower folded portion 176 (see FIG. 11). The lower folded portion 176 is a portion made by accordion-folding at least part of the lower area 48, which is to be situated at the lower side of the airbag 40 upon inflation and deployment.

In FIG. 9, the portion of the lower area 48 facing toward the front of the vehicle is folded multiple times along the fold lines 88 toward the inflator 30, such that the direction of the fold lines of the lower area 48 gradually changes from the direction parallel to the longitudinal direction of the inflator 30 to the direction perpendicular thereto. The direction of the fold lines of the lower area 48 changes such that the center of the rotation of folding is situated at a point between the upper end 31 of the inflator 30 and the middle folded portion 175. The way of folding along the fold lines 88 may be the accordion fold that creates pleats resembling the bellows of an accordion. The way of folding, however, may be selected according to the way the airbag 40 is stored at the side 22 of the backrest 14, and may alternatively be the roll-fold that creates a spiral-shaped roll.

FIG. 11 is a schematic side elevation view illustrating an example of the airbag apparatus 1 with the lower area 48 of the airbag 40 being folded. The airbag apparatus 1 having the folded airbag 40 as illustrated in FIG. 11 is stored at the side 22 of the backrest 14. The entirety of the folded airbag 40 may be further folded from the folded state illustrated in FIG. 11 according to the shape of the storage at the side 22. For example, the middle folded portion 175 having the upper folded portion 171 wrapped therein may be folded against an inflator enclosed portion 174 by folding along a fold line between the inflator enclosed portion 174 and the middle folded portion 175. The inflator enclosed portion 174 is a vehicle-rear-side portion of the lower area 48 in which the inflator 30 is enclosed.

In the following, a description will be given of an example of the process of inflation and deployment of the airbag 40 from the state in which the airbag apparatus 1 is stored at the side 22 of the backrest 14 with the airbag 40 being folded according to the first folding method. In this case, the inflation and deployment of the airbag 40 proceed as illustrated in FIG. 11, FIG. 9 (FIG. 10), FIG. 7 (FIG. 8), and FIG. 5 (FIG. 6) in this order, being reverse to the order in which the first folding method proceeds.

In response to gas supplied to the lower folded portion 176 (see FIG. 11) from the inflator 30, the lower folded portion 176 starts to be unfolded along the fold lines 88 (see FIG. 9). With the unfolding of the lower folded portion 176 along the fold lines 88, the lower area 48 inflates and deploys in a direction 48a (see FIG. 1) toward a space between the side face 19b of the center console 19 and both the abdominal area 10c and the lumbar area 10d. As a result, the lower area 48 is able to receive the abdominal area 10c and the lumbar area 10d of the occupant 10. The accordion folding of the lower folded portion 176 that has pleats like the bellows of an accordion ensures that the deployment path of the lower area 48 is unlikely to deviate from the direction 48a.

As the gas from the inflator 30 is supplied to the middle folded portion 175 (see FIGS. 9 and 10), the outward-roll-folding of the middle folded portion 175 starts to unfold. As the outward-roll-folding of the middle folded portion 175 unfolds, the middle area 47 inflates and deploys in a direction 47a (see FIG. 1) toward an upper space over the center console 19. As a result, the middle area 47 is able to receive the arm 10b (i.e., a shoulder area in particular) of the occupant 10.

The middle folded portion 175 is outward-roll-folded such that the outside face of the airbag opposite from the side 22 faces inwards in the roll. Due to the outward-roll-folding, the rotational force of the unfolding middle folded portion 175 acts such that the middle area 47 inflates and deploys while exerting a force toward the side 22. As a result, the outward-roll-fold unfolds along the arm 10b (especially, along the upper arm from the shoulder to the elbow) when the middle folded portion 175 upon inflation and deployment passes alongside the arm 10b. As a result, the deployment path of the airbag 40 is unlikely to deviate away from the arm 10b of the occupant 10 in the vehicle width direction.

In response to gas supplied to the upper folded portion 171 (see FIGS. 7 and 8) from the inflator 30, the upper folded portion 171 starts to be unfolded along the fold lines 89. As the upper folded portion 171 unfolds along the fold lines 89, the upper area 46 inflates and deploys in a direction 46a (see FIG. 1) toward the top of the vehicle in the upper space over the center console 19. As a result, the upper area 46 is able to receive the head 10a of the occupant 10. Further, the accordion folding of the upper folded portion 171 that has pleats like the bellows of an accordion ensures that the deployment path of the upper area 46 is unlikely to deviate from the direction 46a.

### <Second Method of Folding>

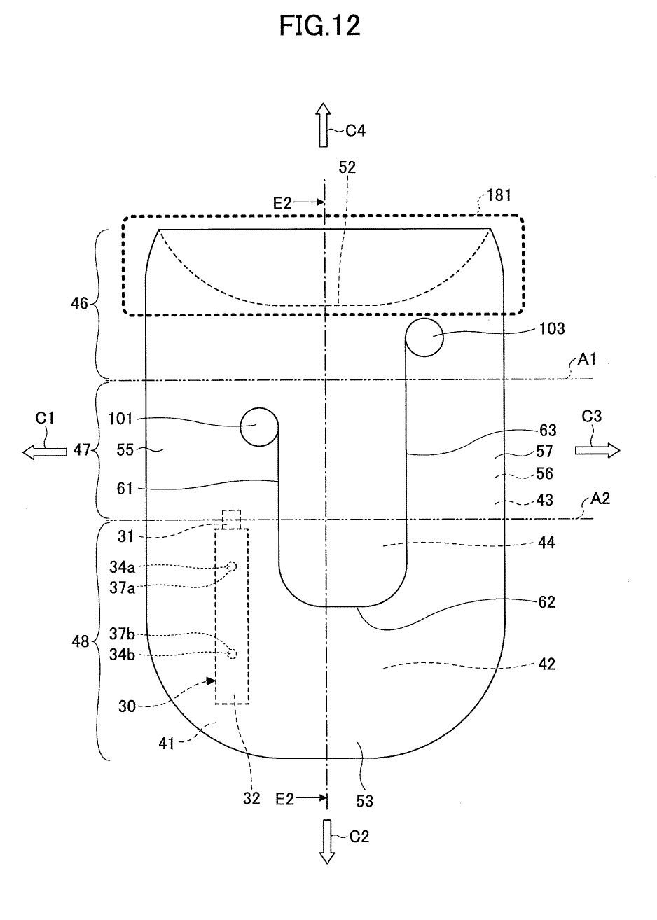

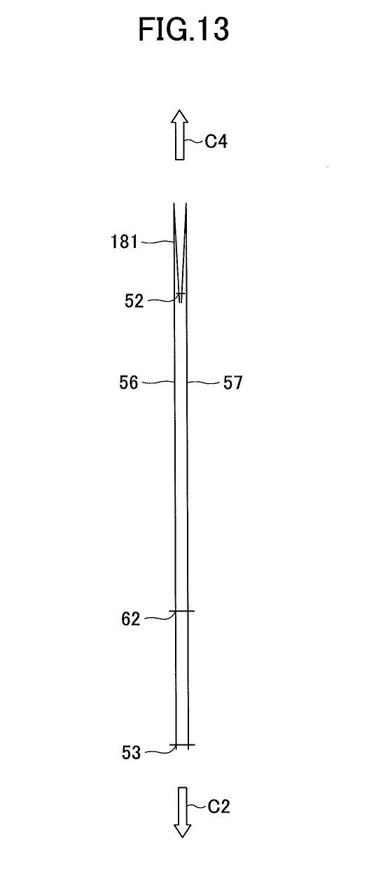

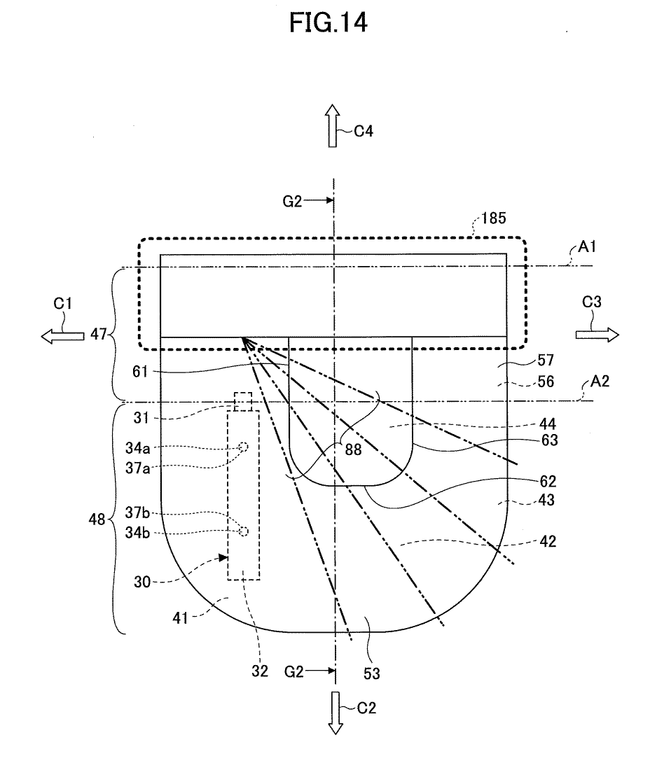

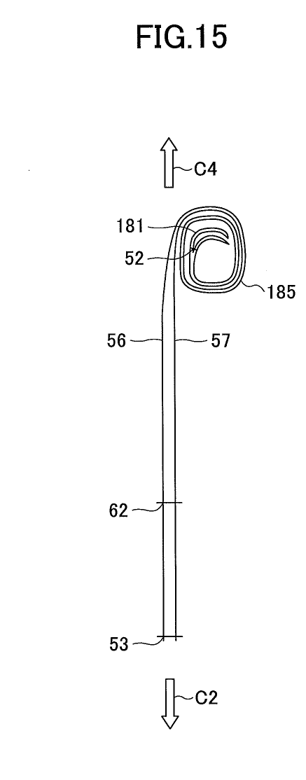

In the second method of folding, the steps of folding the airbag 40 are performed as illustrated in FIG. 5 (FIG. 6), FIG. 12 (FIG. 13), FIG. 14 (FIG. 15), and FIG. 11 in this order. A description of those parts of the second folding method that are the same as or similar to those of the first folding method will be omitted or simplified by reference to the above description of the first folding method.

FIG. 12 is a schematic side elevation view illustrating an example of the airbag apparatus 1 with the upper area 46 of the airbag 40 being folded.

FIG. 13 is a schematic cross-sectional view taken along the line E2-E2 in FIG. 12. In FIGS. 12 and 13, the upper periphery 52 of the upper area 46 is valley-folded (tucked in) toward the lower periphery 53 such that the inside face of the airbag 40 faces inward, thereby creating an upper folded portion 181. The upper folded portion 181 is a portion made by tucking in at least part of the upper area 46, which is to be situated at the upper side of the airbag 40 upon inflation and deployment.

FIG. 14 is a schematic side elevation view illustrating an example of the airbag apparatus 1 with the middle area 47 of the airbag 40 being folded. FIG. 15 is a schematic cross-sectional view taken along the line G2-G2 in FIG. 14. In FIGS. 14 and 15, at least part of the middle area 47 of the airbag 40 is outward-roll-folded such that the upper folded portion 181 is wrapped inside the roll, thereby creating a middle folded portion 185. The middle folded portion 185 is an outward-roll-folded portion made of at least part of the middle area 47 situated between the upper area 46 and the lower area 48 upon the inflation and deployment of the airbag 40. The middle folded portion 185 is an outward-roll-folded portion of the middle area 47 in which the upper folded portion 181 is wrapped.

A description of the way to fold the lower area 48 will be omitted by reference to the previous description.

In the following, a description will be given of an example of the process of inflation and deployment of the airbag 40 from the state in which the airbag apparatus 1 is stored at the side 22 of the backrest 14 with the airbag 40 being folded according to the second folding method. In this case, the inflation and deployment of the airbag 40 proceed as illustrated in FIG. 11, FIG. 14 (FIG. 15), FIG. 12 (FIG. 13), and FIG. 5 (FIG. 6) in this order, being reverse to the order in which the second folding method proceeds.

In the second folding method also, the middle folded portion 185 is outward-roll-folded such that the outside face of the airbag 40 opposite from the side 22 faces inwards in the roll. As a result, the outward-roll-fold unfolds along the arm 10b (especially, along the upper arm from the shoulder to the elbow) when the middle folded portion 185 upon inflation and deployment passes alongside the arm 10b, similarly to the first folding method. As a result, the deployment path of the airbag 40 is unlikely to deviate away from the arm 10b of the occupant 10 in the vehicle width direction.

Descriptions of other aspects of inflation and deployment in the case of the second folding method are the same as or similar to those of the first folding method, and will be omitted by reference to the previous descriptions.

### <Third Method of Folding>

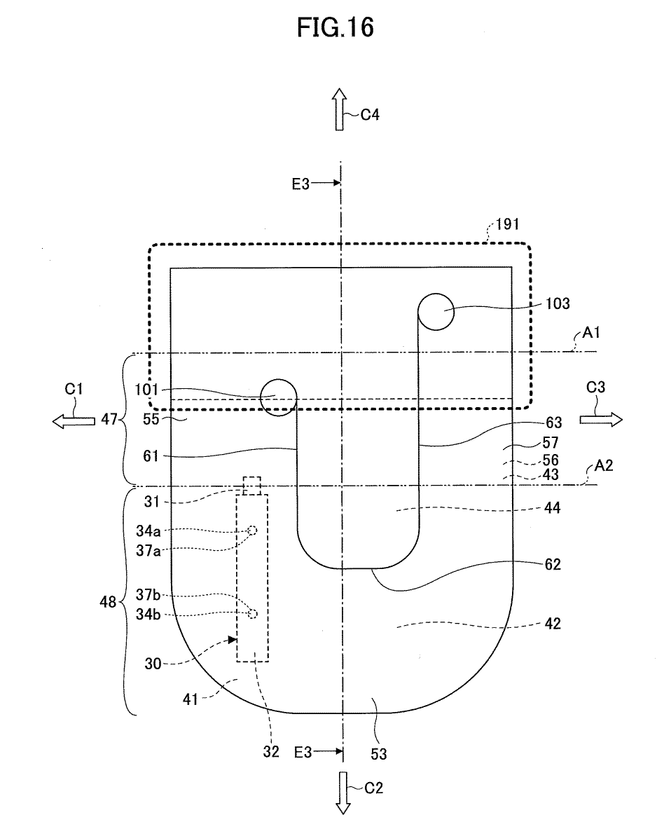

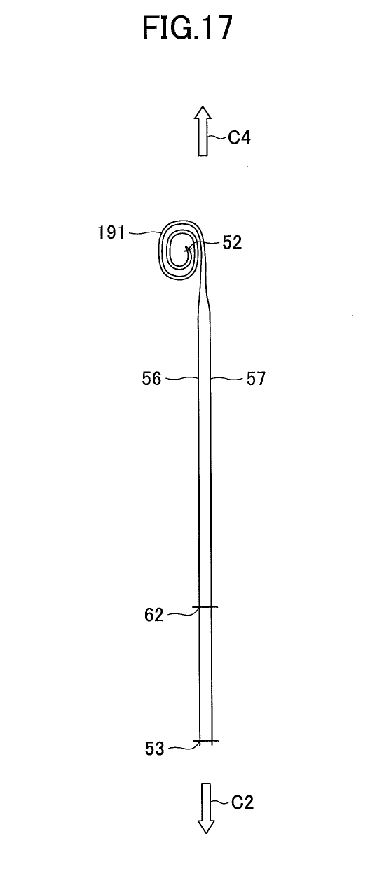

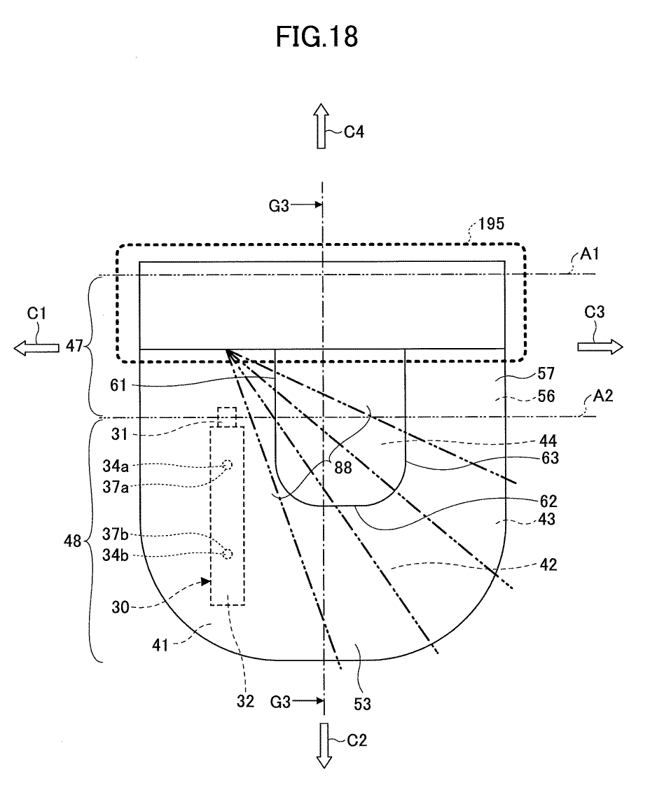

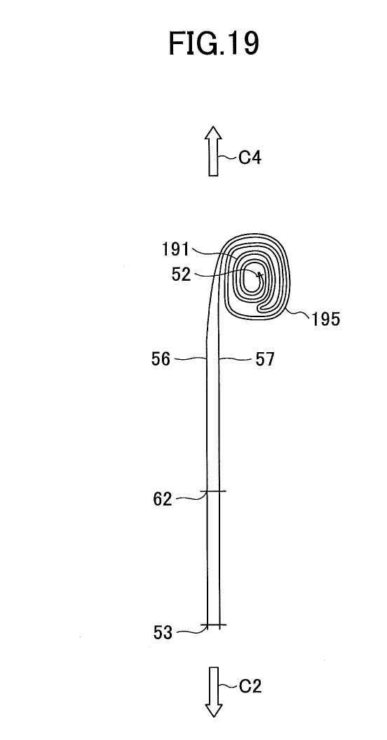

In the third method of folding, the steps of folding the airbag 40 are performed as illustrated in FIG. 5 (FIG. 6), FIG. 16 (FIG. 17), FIG. 18 (FIG. 19), and FIG. 11 in this order. A description of those parts of the third folding method that are the same as or similar to those of the first folding method will be omitted or simplified by reference to the above description of the first folding method.

FIG. 16 is a schematic side elevation view illustrating an example of the airbag apparatus 1 with the upper area 46 of the airbag 40 being folded. FIG. 17 is a schematic cross-sectional view taken along the line E3-E3 in FIG. 16. In FIGS. 16 and 17, the airbag 40 is rolled in the longitudinal direction thereof from the upper periphery 52 to the lower periphery 53.

At least part of the upper area 46 of the airbag 40 is rolled (also referred to as “inwardly rolled) with the first panel 56 facing inwards, thereby creating an upper folded portion 191. The upper folded portion 191 is a portion made by inwardly rolling at least part of the upper area 46, which is to be situated at the upper side of the airbag 40 upon inflation and deployment. The inward rolling in this context means that the roll is created such that the face (inside face) of the airbag 40 facing toward the side 22 upon inflation and deployment faces inward in the roll.

FIG. 18 is a schematic side elevation view illustrating an example of the airbag apparatus 1 with the middle area 47 of the airbag 40 being folded. FIG. 19 is a schematic cross-sectional view taken along the line G3-G3 in FIG. 18. In FIGS. 18 and 19, at least part of the middle area 47 of the airbag 40 is outward-roll-folded such that the upper folded portion 191 is wrapped inside the roll, thereby creating a middle folded portion 195. The middle folded portion 195 is an outward-roll-folded portion made of at least part of the middle area 47 situated between the upper area 46 and the lower area 48 upon the inflation and deployment of the airbag 40. The middle folded portion 195 is an outward-roll-folded portion of the middle area 47 in which the upper folded portion 191 is wrapped.

A description of the way to fold the lower area 48 will be omitted by reference to the previous description.

In the following, a description will be given of an example of the process of inflation and deployment of the airbag 40 from the state in which the airbag apparatus 1 is stored at the side 22 of the backrest 14 with the airbag 40 being folded according to the third folding method. In this case, the inflation and deployment of the airbag 40 proceed as illustrated in FIG. 11, FIG. 18 (FIG. 19), FIG. 16 (FIG. 17), and FIG. 5 (FIG. 6) in this order, being reverse to the order in which the third folding method proceeds.

In the third folding method also, the middle folded portion 195 is outward-roll-folded such that the outside face of the airbag 40 opposite from the side 22 faces inwards in the roll. As a result, the outward-roll-fold unfolds along the arm 10b (especially, along the upper arm from the shoulder to the elbow) when the middle folded portion 195 upon inflation and deployment passes alongside the arm 10b, similarly to the first folding method. As a result, the deployment path of the airbag 40 is unlikely to deviate away from the arm 10b of the occupant 10 in the vehicle width direction.

Descriptions of other aspects of inflation and deployment in the case of the third folding method are the same as or similar to those of the first folding method, and will be omitted by reference to the previous descriptions.

### <Fourth Method of Folding>

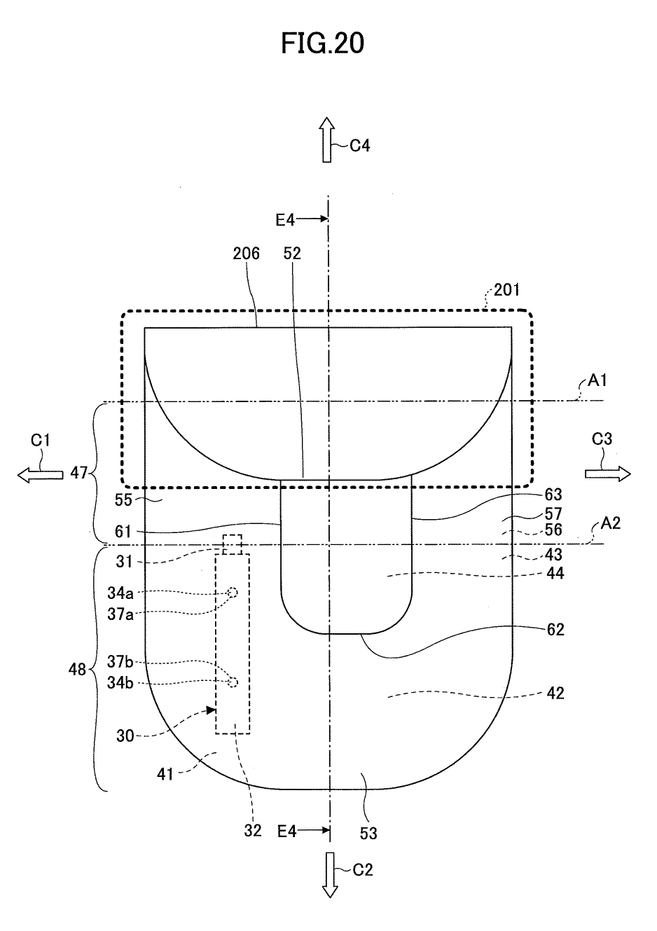

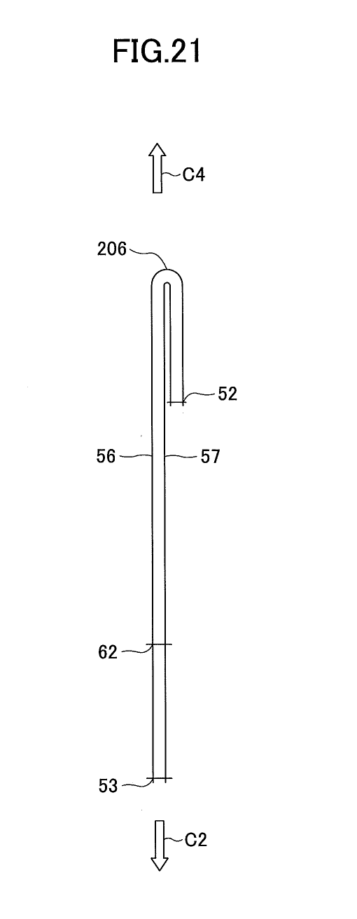

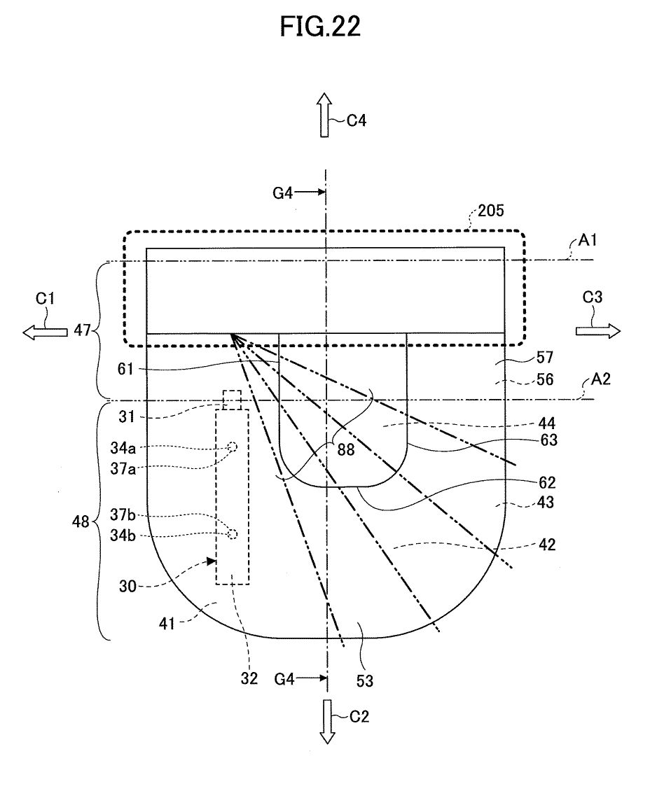

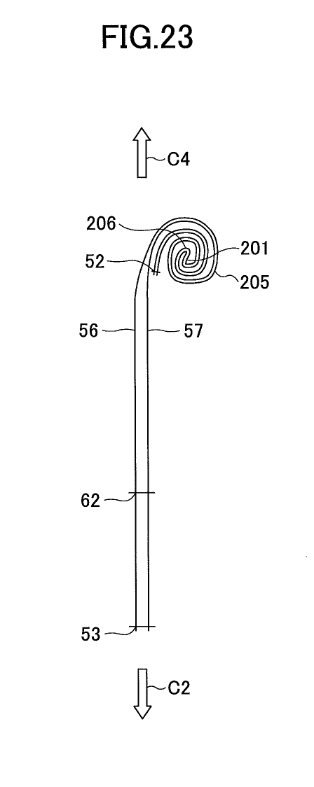

In the fourth method of folding, the steps of folding the airbag 40 are performed as illustrated in FIG. 5 (FIG. 6), FIG. 20 (FIG. 21), FIG. 22 (FIG. 23), and FIG. 11 in this order. A description of those parts of the fourth folding method that are the same as or similar to those of the first folding method will be omitted or simplified by reference to the above description of the first folding method.

FIG. 20 is a schematic side elevation view illustrating an example of the airbag apparatus 1 with the upper area 46 of the airbag 40 being folded. FIG. 21 is a schematic cross-sectional view taken along the line E4-E4 in FIG. 20. In FIGS. 20 and 21, the upper periphery 52 of the upper area 46 is folded (also referred to as outwardly-folded) along a mountain-fold part 206 toward the lower periphery such that the second panel 57 faces inward, thereby creating an upper folded portion 201. The upper folded portion 201 is a portion made by outwardly folding at least part of the upper area 46, which is to be situated at the upper side of the airbag 40 upon inflation and deployment. The outward-fold in this context means that the fold is created such that the face (outside face) of the airbag 40 opposite the face (inside face) facing toward the side 22 upon inflation and deployment faces inward.

FIG. 22 is a schematic side elevation view illustrating an example of the airbag apparatus 1 with the middle area 47 of the airbag 40 being folded. FIG. 23 is a schematic cross-sectional view taken along the line G4-G4 in FIG. 22. In FIGS. 22 and 23, at least part of the middle area 47 of the airbag 40 is outward-roll-folded such that the upper folded portion 201 is wrapped inside the roll, thereby creating a middle folded portion 205. The middle folded portion 205 is an outward-roll-folded portion made of at least part of the middle area 47 situated between the upper area 46 and the lower area 48 upon the inflation and deployment of the airbag 40. The middle folded portion 205 is an outward-roll-folded portion of the middle area 47 in which the upper folded portion 201 is wrapped.

A description of the way to fold the lower area 48 will be omitted by reference to the previous description.

In the following, a description will be given of an example of the process of inflation and deployment of the airbag 40 from the state in which the airbag apparatus 1 is stored at the side 22 of the backrest 14 with the airbag 40 being folded according to the fourth folding method. In this case, the inflation and deployment of the airbag 40 proceed as illustrated in FIG. 11, FIG. 22 (FIG. 23), FIG. 20 (FIG. 21), and FIG. 5 (FIG. 6) in this order, being reverse to the order in which the fourth folding method proceeds.

In the fourth folding method also, the middle folded portion 205 is outward-roll-folded such that the outside face of the airbag 40 opposite from the side 22 faces inwards in the roll. As a result, the outward-roll-fold unfolds along the arm 10b (especially, along the upper arm from the shoulder to the elbow) when the middle folded portion 195 upon inflation and deployment passes alongside the arm 10b, similarly to the first folding method. As a result, the deployment path of the airbag 40 is unlikely to deviate away from the arm 10b of the occupant 10 in the vehicle width direction.

Descriptions of other aspects of inflation and deployment in the case of the fourth folding method are the same as or similar to those of the first folding method, and will be omitted by reference to the previous descriptions.

### <Fifth Method of Folding>

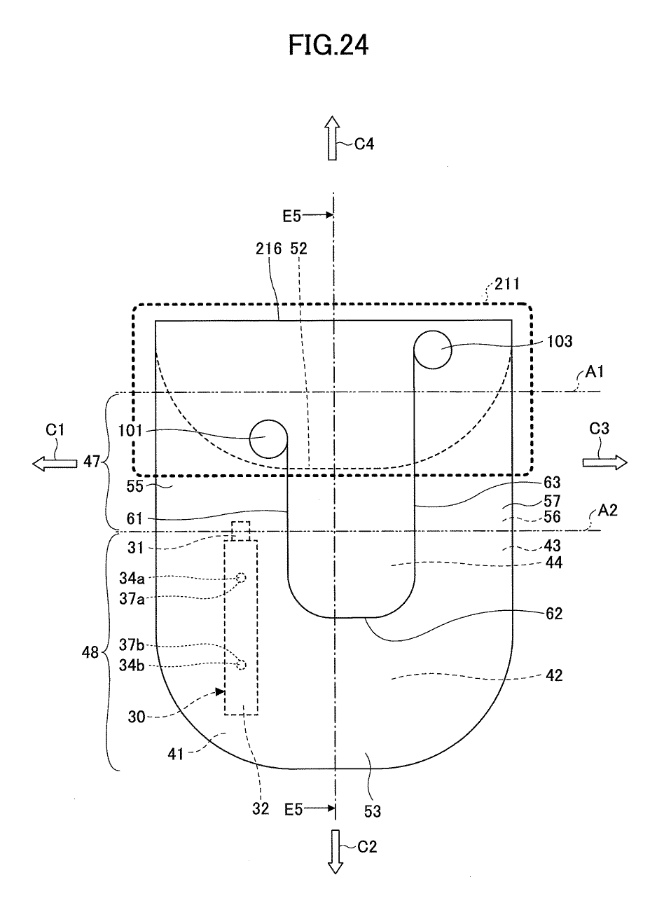

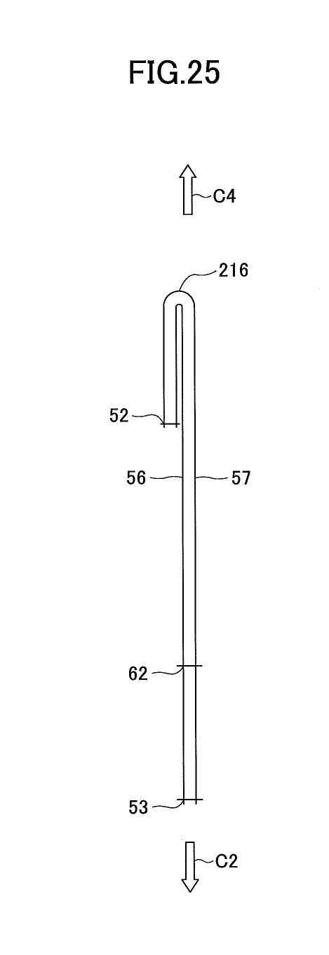

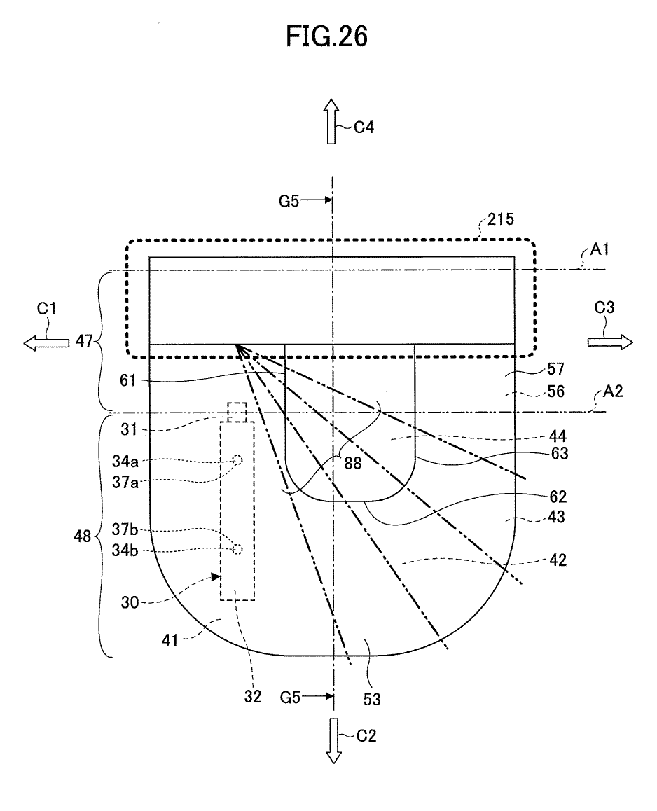

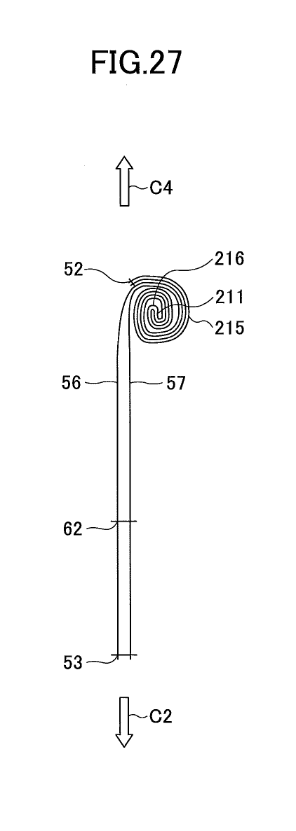

In the fifth method of folding, the steps of folding the airbag 40 are performed as illustrated in FIG. 5 (FIG. 6), FIG. 24 (FIG. 25), FIG. 26 (FIG. 27), and FIG. 11 in this order. A description of those parts of the fifth folding method that are the same as or similar to those of the first folding method will be omitted or simplified by reference to the above description of the first folding method.

FIG. 24 is a schematic side elevation view illustrating an example of the airbag apparatus 1 with the upper area 46 of the airbag 40 being folded. FIG. 25 is a schematic cross-sectional view taken along the line E5-E5 in FIG. 24. In FIGS. 24 and 25, the upper periphery 52 of the upper area 46 is folded (also referred to as inwardly-folded) along a mountain-fold part 216 toward the lower periphery 53 such that the first panel 56 faces inward, thereby creating an upper folded portion 211. The upper folded portion 211 is a portion made by inwardly folding at least part of the upper area 46, which is to be situated at the upper side of the airbag 40 upon inflation and deployment. The inward fold in this context means that the fold is created such that the face (inside face) of the airbag 40 facing toward the side 22 upon inflation and deployment faces inward.

FIG. 26 is a schematic side elevation view illustrating an example of the airbag apparatus 1 with the middle area 47 of the airbag 40 being folded. FIG. 27 is a schematic cross-sectional view taken along the line G5-G5 in FIG. 26. In FIGS. 26 and 27, at least part of the middle area 47 of the airbag 40 is outward-roll-folded such that the upper folded portion 211 is wrapped inside the roll, thereby creating a middle folded portion 215. The middle folded portion 215 is an outward-roll-folded portion made of at least part of the middle area 47 situated between the upper area 46 and the lower area 48 upon the inflation and deployment of the airbag 40. The middle folded portion 215 is an outward-roll-folded portion of the middle area 47 in which the upper folded portion 211 is wrapped.

A description of the way to fold the lower area 48 will be omitted by reference to the previous description.

In the following, a description will be given of an example of the process of inflation and deployment of the airbag 40 from the state in which the airbag apparatus 1 is stored at the side 22 of the backrest 14 with the airbag 40 being folded according to the fifth folding method. In this case, the inflation and deployment of the airbag 40 proceed as illustrated in FIG. 11, FIG. 26 (FIG. 27), FIG. 24 (FIG. 25), and FIG. 5 (FIG. 6) in this order, being reverse to the order in which the fifth folding method proceeds.

In the fifth folding method also, the middle folded portion 215 is outward-roll-folded such that the outside face of the airbag 40 opposite from the side 22 faces inwards in the roll. As a result, the outward-roll-fold unfolds along the arm 10b (especially, along the upper arm from the shoulder to the elbow) when the middle folded portion 215 upon inflation and deployment passes alongside the arm 10b, similarly to the first folding method. As a result, the deployment path of the airbag 40 is unlikely to deviate away from the arm 10b of the occupant 10 in the vehicle width direction.

Descriptions of other aspects of inflation and deployment in the case of the fifth folding method are the same as or similar to those of the first folding method, and will be omitted by reference to the previous descriptions.

Although the airbag and the airbag apparatus have been described by referring to the embodiments, the present invention is not limited to these embodiments. Various modifications and improvements such as combining or replacing an embodiment partially or entirely with one or more other embodiments may be made without departing from the scope of the present invention.

For example, the backrest in which the airbag is stored is not limited to the backrest of a front seat, and may be the backrest of a rear seat.

The present application is based on and claims the benefit of priority of Japanese priority application No. 2015-236998 filed on Dec. 3, 2015, with the Japanese Patent Office, the entire contents of which are hereby incorporated by reference.

What is claimed is:

1. An airbag for installation in a backrest of a seat disposed in a vehicle and for storage in a folded state at an inner side of the backrest in a vehicle width direction, comprising:
a lower folded portion made by folding a lower area of the airbag that is to be situated at a lower side of vehicle upon inflation and deployment of the airbag;
an upper folded portion made by folding an upper area of the airbag that is to be situated at an upper side of vehicle upon the inflation and deployment of the airbag; and
a middle folded portion made by folding a middle area of the airbag that is to be situated between the lower area and the upper area upon the inflation and deployment of the airbag,
wherein the middle folded portion is a roll-folded portion such that a face of the airbag facing away from the inner side upon the inflation and deployment of the airbag faces inward in the roll-folded portion, the roll-folded portion having the upper folded portion wrapped therein.

2. The airbag as claimed in claim 1, wherein the upper folded portion is an accordion fold having a plurality of pleats.

3. The airbag as claimed in claim 1, wherein the lower folded portion is an accordion fold having a plurality of pleats.

4. An airbag apparatus, comprising:
the airbag of claim 1; and
an inflator configured to generate gas to inflate and deploy the airbag.
